(19) United States
(12) Patent Application Publication
(10) Pub. No.: US 2006/0047088 A1
(43) Pub. Date: Mar. 2, 2006

(54) High-molecular aliphatic polyester and process for producing the same

(75) Inventors: Kazuyuki Yamane, Iwaki-shi (JP); Ryo Kato, Iwaki-shi (JP); Toshihiko Ono, Iwaki-shi (JP)

Correspondence Address: DINSMORE & SHOHL, LLP, 1900 CHEMED CENTER, 255 EAST FIFTH STREET, CINCINNATI, OH, 45202, US

(73) Assignee: Kureha Chemical Industry Company, Limited, Tokyo (JP)

(21) Appl. No.: 10/529,449

(22) PCT Filed: Oct. 8, 2003
(86) PCT No.: PCT/JP03/12882

§ 371 Date: Mar. 28, 2005

(30) Foreign Application Priority Data
Oct. 8, 2002 (JP) 2002-295276

(51) Int. Cl. C08F 8/30; C08L 67/00; B32B 27/36

(52) U.S. Cl. 525/375; 525/374; 525/437

(57) ABSTRACT

Disclosed herein are a high-molecular weight aliphatic polyester, whose molecular weight has been highly increased by a chain-lengthening reaction of a ring-opening (co)polymer of at least one cyclic ester selected from the group consisting of glycolide and lactide with an oxazoline compound, and a production process thereof. The molecular weight of the high-molecular weight aliphatic polyester is highly increased to the extent that a rate of increase in molecular weight represented by a ratio (Mw₂/Mw₁) of a weight average molecular weight (Mw₂) of a ring-opening (co)polymer after the chain lengthening to a weight average molecular weight (Mw₁) of the ring-opening (co)polymer before the chain lengthening amounts to at least 1.10.

### TECHNICAL FIELD

The present invention relates to a high-molecular weight aliphatic polyester, whose molecular weight has been highly increased by a reaction of a ring-opening (co)polymer of at least one cyclic ester selected from the group consisting of glycolide and lactide with a chain-lengthening agent, and a production process thereof. The high-molecular weight aliphatic polyester according to the present invention is high in molecular weight and excellent in heat resistance and can be used in a wide variety of fields as extruded products such as sheets, films and fibers, compression-molded products, injection-molded products, blow-molded products, composite materials (multi-layer films and multi-layer containers), and other formed or molded products.

### BACKGROUND ART

Aliphatic polyesters such as polyglycolic acid and polylactic acid are biodegradable resins degraded by microorganisms or enzymes present in the natural world such as soil and sea because they contain aliphatic ester linkages in their molecular chains. These aliphatic polyesters are useful as medical polymer materials for surgical sutures, artificial skins, etc. because they have degradability and absorbability in vivo and biocompatibility (for example, U.S. Pat. No. 3,297,033).

Among the aliphatic polyesters, the polyglycolic acid is markedly excellent in gas barrier properties, and so its new uses have been developed as sheets, films, containers, etc. (for example, JP-A 10-60136, JP-A 10-80990, JP-A 10-138371 and JP-A 10-337772).

The polyglycolic acid can be produced by dehydration polycondensation of glycolic acid, dealcoholization polycondensation of an alkyl glycolate, desalting polycondensation of a glycolic acid salt, or the like. However, these polycondensation reactions are difficult to provide a high-molecular weight polyglycolic acid. To the contrary, when glycolide, which is a bimolecular cyclic ester (also referred to as “cyclic dimer”) of glycolic acid, is subjected to ring-opening polymerization, comparatively high-molecular weight polyglycolic acid can be provided. The ring-opening polymer of the glycolide may be called polyglycolide in some cases.

A polycondensation reaction of lactic acid, lactate or lactic acid salt is also difficult to provide polylactic acid as a high-molecular weight polymer. Therefore, the polylactic acid is generally synthesized by ring-opening that is a bimolecular cyclic ester of lactic acid. The ring-opening polymer of the lactide may be called polylactide in some cases. The glycolide and lactide may also be subjected to ring-opening copolymerization.

With the advancement of technical development as to ring-opening (co)polymers of cyclic esters and the attempt to develop their new uses, the ring-opening (co)polymers are required to improve their mechanical strength, heat resistance, forming or molding and processing ability, and the like. In particular, since physical properties of the ring-opening (co)polymers, such as mechanical strength, mainly depend on their molecular weights, there is a strong demand for increase of their molecular weights.

According to the ring-opening (co)polymerization of the cyclic ester of the glycolide or lactide, a comparatively high-molecular weight aliphatic polyester can be provided compared with the polycondensation of glycolic acid, lactic acid or the like. However, it has not been yet sufficient in the light of the state of requirements in recent years, and problems to be solved have been left to the increase in molecular weight.

First, in order to synthesize a high-molecular weight aliphatic polyester by ring-opening (co)polymerization of a cyclic ester, it is necessary to use a high-purity monomer(s). However, the glycolide or lactide is difficult to highly purify it, in addition to the fact that its own for a purifying treatment. It has therefore been extremely difficult to supply a high-molecular weight aliphatic polyester in an industrially great amount at a low price according to the production process in which the high-purity monomer(s) must be used.

Second, the aliphatic polyester tends to greatly vary its molecular weight according to slight changes in polymerization conditions such as polymerization temperature, polymerization time, polymerization pressure, and the kinds and amounts of a catalyst and additives in addition to the purity of the monomer(s). It has therefore been difficult to stably produce a high-molecular weight aliphatic polyester.

Third, even when a high-molecular weight aliphatic polyester is synthesized under strict control of the purity of the monomer(s) and the polymerization conditions, the level of its molecular weight is not always said to be sufficient. For example, the weight average molecular weight (Mw) of polyglycolic acid obtained by the ring-opening polymerization of glycolide is about 100,000. In order to produce a formed or molded product having high physical properties, it is necessary to further increase the molecular weight of the aliphatic polyester.

Since the physical properties of an aliphatic polyester, such as mechanical strength, mainly depend on its molecular weight as described above, there is a demand for development of a process for increasing the molecular weight of the aliphatic polyester by a simple and cheap method. The conventional aliphatic polyesters have involved a problem that heat resistance is insufficient, and so they tend to undergo thermal decomposition when exposed to high-temperature conditions upon their melt processing or the like. In addition, a molecular weight distribution is desirably relatively broad from the viewpoint of forming or molding and processing ability. It has however been difficult to provide an aliphatic polyester having a high molecular weight and a broad molecular weight distribution by the conventional production processes.

### DISCLOSURE OF THE INVENTION

It is an object of the present invention to provide a high-molecular weight aliphatic polyester that is a ring-opening (co)polymer of a cyclic ester such as glycolide or lactide, whose molecular weight has been highly increased, and whose heat resistance and forming or molding and processing ability have been improved.

Another object of the present invention is to provide a process for producing a high-molecular weight aliphatic polyester, by which the molecular weight of the resulting polymer can be easily increased to a desired molecular weight without need of always using high-purity glycolide or lactide as a starting material, and heat resistance and forming or molding and processing ability are also improved.

The present inventors have carried out an extensive investigation with a view toward achieving the above objects. As a result, it has been found that a ring-opening (co)polymer of at least one cyclic ester selected from the group consisting of glycolide and lactide is subjected to a chain-lengthening reaction with an oxazoline compound, whereby the chain of the ring-opening (co)polymer is lengthened to highly increase its molecular weight. Reaction conditions for the chain-lengthening reaction, such as the amount of the oxazoline compound used, reaction temperature, and reaction time are controlled, whereby the molecular weight and molecular weight distribution of the resulting polymer can be controlled, and an aliphatic polyester, whose molecular weight has been highly increased to the extent that the conventional processes have been unable to achieve, can be provided.

According to the process of the present invention, even the simple use of the oxazoline compound as the chain-lengthening agent can produce a high-molecular weight aliphatic polyester. In addition, the high-molecular weight aliphatic polyester obtained by the production process according to the present invention becomes high in weight loss-starting temperature on heating and is hence markedly improved in heat resistance. Since the high-molecular weight aliphatic polyester according to the present invention is moderately broad in molecular weight distribution, the forming or molding and processing ability thereof is improved. In the present invention, the oxazoline compound acts as a chain-lengthening agent, not assume an action as a chain terminator. The present invention has been led to completion on the basis of these findings.

According to the present invention, there is thus provided a high-molecular weight aliphatic polyester, whose molecular weight has been highly increased by a chain-lengthening reaction of a ring-opening (co)polymer of at least one cyclic ester selected from the group consisting of glycolide and lactide with an oxazoline compound to the extent that a rate of increase in molecular weight represented by a ratio (Mw₂/Mw₁) of a weight average molecular weight (Mw₂) of a ring-opening (co)polymer after the chain lengthening to a weight average molecular weight (Mw₁) of the ring-opening (co)polymer before the chain lengthening amounts to at least 1.10.

According to the present invention, there is also provided a process for producing a high-molecular weight aliphatic polyester, which comprises subjecting a ring-opening (co)polymer of at least one cyclic ester selected from the group consisting of glycolide and lactide to a chain-lengthening reaction with an oxazoline compound to highly increase the molecular weight thereof to the extent that a rate of increase in molecular weight represented by a ratio (Mw₂/Mw₁) of a weight average molecular weight (Mw₂) of a ring-opening (co)polymer after the chain lengthening to a weight average molecular weight (Mw₁) of the ring-opening (co)polymer before the chain lengthening amounts to at least 1.10.

### BEST MODE FOR CARRYING OUT THE INVENTION

1. Ring-Opening (Co)Polymer

The ring-opening (co)polymer of a cyclic ester can be obtained by subjecting glycolide, lactide or a mixture of glycolide and lactide to ring-opening (co)polymerization. The glycolide is a bimolecular cyclic ester of glycolic acid and can be suitably produced by, for example, depolymerization of a glycolic acid oligomer. The lactide is a bimolecular cyclic ester of lactic acid and may be any of an L body, a D body, a racemic body and a mixture thereof.

Among these, the glycolide is suitable for use as a starting material because it is difficult to purchase a high-purity product in a great amount and at a low price. The reason for it is that according to the process of the present invention, a high-molecular weight polyglycolic acid (polyglycolide) can be finally obtained without need of always using high-purity glycolide.

Since the polyglycolic acid is excellent in gas barrier properties, a monomer comprising glycolide as a main component is desirably used when the resulting polyglycolic acid is used in application fields of sheets, films, containers, composite materials, etc. In the monomer comprising glycolide as a main component, the proportion of the glycolide is preferably at least 55% by weight, more preferably at least 70% by weight, particularly preferably at least 90% by weight. It goes without saying that the glycolide may be used by itself.

In the present invention, glycolide, lactide or a mixture thereof is used as a monomer, and any of cyclic monomers such as lactones (for example, β-propiolactone, β-butyrolactone, pivalolactone, γ-butyrolactone, δ-valero-lactone, β-methyl-δ-valerolactone, ε-caprolactone, etc.), trimethylene carbonate and 1,3-dioxane may be used in combination as another comonomer. These comonomers are used in a proportion of generally at most 45% by weight, preferably at most 30% by weight, more preferably at most 10% by weight. If the proportion of these comonomers is too high, the crystallinity of a ring-opening copolymer formed when used in combination of, for example, glycolide is impaired, and its heat resistance, gas barrier properties, mechanical strength, etc. are deteriorated.

The ring-opening (co)polymerization of the cyclic ester is preferably conducted in the presence of a small amount of a catalyst. No particular limitation is imposed on the catalyst. As examples thereof, may be mentioned tin compounds such as tin halides (for example, tin dichloride, tin tetrachloride, etc.) and organic tin carboxylates (for example, tin octanoates such as tin 2-ethylhexanoate); titanium compounds such as alkoxytitanates; aluminum compounds such as alkoxyaluminum; zirconium compounds such as zirconium acetylacetone; and antimony compounds such as antimony halides and antimony oxide. The amount of the catalyst used is preferably about 1 to 1,000 ppm, more preferably about 3 to 300 ppm in terms of a weight ratio based on the cyclic ester.

The ring-opening (co)polymerization of the cyclic ester may be conducted by either bulk polymerization or solution polymerization and is optional. In many cases, however, the bulk polymerization is adopted. A higher alcohol such as lauryl alcohol, water or the like may be used as a molecular weight modifier for the purpose of regulating the molecular weight of the resulting polymer. In addition, a polyhydric alcohol such as glycerol may be added for the purpose of improving the physical properties of the resulting polymer.

A polymerizer for the bulk polymerization may be suitably selected from among various kinds of apparatus such as extruder type, vertical type having a paddle blade, vertical type having a helical ribbon blade, horizontal type such as an extruder type or kneader type, ampoule type, plate type and annular type. Various kinds of reaction vessels may be used for the solution polymerization.

The polymerization temperature can be suitably preset within a range of from 120° C. which is a substantial polymerization-initiating temperature, to 300° C. as necessary for the end application intended. The polymerization temperature is preferably 130 to 250° C., more preferably 140 to 230° C., particularly preferably 150 to 225° C. If the polymerization temperature is too high, a polymer formed tends to undergo thermal decomposition. The polymerization time is within a range of from 3 minutes to 20 hours, preferably from 5 minutes to 18 hours. If the polymerization time is too short, it is hard to sufficiently advance the polymerization. If the polymerization time is too long, a polymer formed tends to be colored.

No particular limitation is imposed on the molecular weight of the ring-opening (co)polymer of the cyclic ester. Even in a ring-opening (co)polymer having a relatively low molecular weight, its molecular weight can be highly increased by subjecting it to a chain-lengthening reaction with an oxazoline compound. In order to efficiently increase the molecular weight by the reaction with the oxazoline compound to provide an aliphatic polyester having a sufficiently high molecular weight, the weight average molecular weight (Mw) of the ring-opening (co)polymer is of the order of at least 30,000, preferably 30,000 to 500,000, more preferably 30,000 to 110,000.

2. Oxazoline Compound

Examples of the oxazoline compound used in the present invention include 2-oxazoline compounds such as 2-oxazoline, 2-methyl-2-oxazoline, 2-isopropyl-2-oxazoline, 2-butyl-2-oxazoline and 2-phenyl-2-oxazoline; 2,2′-bis(2-oxazoline) compounds such as 2,2′-bis(2-oxazoline), 2,2′-methylene-bis(2-oxazoline), 2,2′-ethylene-bis(2-oxazoline), 2,2′-trimethylene-bis(2-oxazoline), 2,2′-tetramethylene-bis(2-oxazoline), 2,2′-hexamethylene-bis(2-oxazoline), 2,2′-octamethylene-bis(2-oxazoline), 2,2′-ethylene-bis-(4,4′-dimethyl-2-oxazoline), 2,2′-p-phenylene-bis(2-oxazoline) and 2,2′-m-phenylene-bis(2-oxazoline); and bis-(2-oxazolinylcyclohexane) sulfide and polymeric compounds with at least 2 oxazoline ring structures introduced at molecular chain terminals or into side chains thereof.

The oxazoline compound is preferably a compound having at least 2 oxazoline ring structures in its molecule from the viewpoint of efficiently performing the chain-lengthening reaction.

Among the oxazoline compounds, are preferred compounds having 2 oxazoline ring structures in their molecules and represented by the following formula (1):

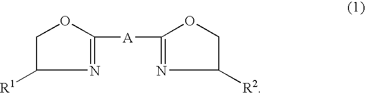

In the formula, A is a single bond or a divalent organic group. As the divalent organic group, is preferred —(CH₂)ₙ—(n is an integer of 1 or greater, preferably 1 to 20 or a phenylene group. R¹ and R² are, individually of each other, an alkyl group (having 1 to 10 carbon atoms) cycloalkyl group, phenyl group or the like, with an alkyl group having 1 to 5 carbon atoms being preferred.

Among the compounds having 2 oxazoline ring structures in their molecules, 2,2′-m-phenylene-bis(2-oxazoline) represented by the following formula (2): 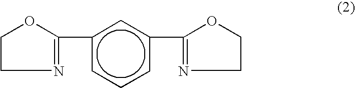
is particularly preferred because it is easily available and excellent in reactivity.

The amount of the oxazoline compound used is preferably 0.001 to 10 parts by weight, more preferably 0.05 to 7 parts by weight, particularly preferably 0.1 to 5 parts by weight per 100 parts by weight of the ring-opening (co)polymer of the cyclic ester. If the amount of the oxazoline compound used is too little, it is difficult to sufficiently increase the molecular weight of the ring-opening (co)polymer. If the amount is too great, the chain-lengthening effect shows a tendency to saturate, and so such a too great amount is not economical. A high-molecular weight aliphatic polyester having a desired molecular weight can be obtained by controlling the amount of the oxazoline compound used.

3. Production Process of High-Molecular Weight Aliphatic Polyester

The oxazoline compound may be added to the reaction system during a ring-opening (co)polymerization reaction of the cyclic ester or after the reaction. In order to stably obtain a high-molecular weight aliphatic polyester having a desired molecular weight, however, the oxazoline compound is desirably added to the resultant ring-opening (co)polymer after completion of the polymerization reaction. The oxazoline compound may be added at a time or in 2 or more portions.

The temperature of a reaction of the ring-opening (co)polymer with the oxazoline compound is within a range of preferably 100 to 300° C., more preferably 150 to 280° C. It is particularly preferred that this reaction temperature be not lower than the melting temperature of the ring-opening (co)polymer, but not higher than 300° C., more preferably not lower than the melting temperature, but not higher than 280° C. The time of the reaction varies according to the reaction temperature and is of the order of preferably from 30 seconds to 100 minutes, more preferably 1 to 60 minutes, still more preferably 5 to 40 minutes, particularly preferably 10 to 30 minutes.

Although the details of the reaction mechanism of the ring-opening (co)polymer with the oxazoline compound are not clearly known at the present stage, the present inventors consider to be as follows. An oxazoline compound such as 2-oxazoline is known to exhibit behavior of living polymerization if selecting conditions. On the other hand, a ring-opening (co polymer of glycolide or lactide has a carboxyl group on at least one terminal. A linkage (O—C) between a carbon atom at a 5-position of an oxazoline ring and an oxygen atom is severed by interaction between this carboxyl group and the oxazoline ring to open the oxazoline ring, and an oxygen atom of the carboxyl group (—COO) is bonded to the carbon atom at the 5-position of the oxazoline ring. It can be considered that the oxazoline compound acts as a chain-lengthening agent by a reaction mechanism including such a reaction. The chain-lengthening reaction with the oxazoline compound is more efficiently performed by using a compound having at least 2 oxazoline rings in its molecule. The reaction with such an oxazoline compound is a chain-lengthening reaction, in which significant increase in the molecular weight of the ring-opening (co)polymer is observed, different from a mere chain-terminating reaction.

4. High-Molecular Weight Aliphatic Polyester

The chain of a ring-opening (co)polymer of a cyclic ester is lengthened by the reaction of the ring-opening (co)polymer with the oxazoline compound to provide a high-molecular weight aliphatic polyester. The molecular weight of the high-molecular weight aliphatic polyester varies according to the molecular weight of the ring-opening (co)polymer used, the amount of the oxazoline compound used, reaction conditions, etc., and no particular limitation is imposed thereon.

According to the process of the present invention, a high-molecular weight aliphatic polyester having a weight average molecular weight (Mw) of preferably at least 120,000, more preferably at least 130,000, particularly preferably at least 150,000 can be obtained. No particular limitation is imposed on the weight average molecular weight (Mw). However, it is of the order of generally 1,000,000, often 500,000.

When glycolide is subjected to ring-opening polymerization, a ring-opening polymer having a weight average molecular weight (Mw) of up to about 100,000 or about 110,000 is obtained. Such a ring-opening polymer is reacted with a small amount of an oxazoline compound, whereby a high-molecular weight aliphatic polyester, whose weight average molecular weight has been increased to the extent of, for example, 150,000 to 250,000, can be easily obtained. The molecular weight can be further increased by controlling reaction conditions of the chain-lengthening reaction, such as the amount of the oxazoline compound used.

A rate of increase in molecular weight by the chain-lengthening reaction of the ring-opening (co)polymer with the oxazoline compound can be represented by a ratio (Mw₂/Mw₁) of a weight average molecular weight (Mw₂) of a ring-opening (co)polymer (i.e., high-molecular weight aliphatic polyester) after chain lengthening to a weight average molecular weight (Mw₁) of the ring-opening (co)polymer before the chain lengthening. According to the process of the present invention, the molecular weight of the ring-opening (co)polymer can be increased until the rate of increase in molecular weight amounts to preferably at least 1.10, more preferably at least 1.20, particularly preferably at least 1.35. No particular limitation is imposed on the upper limit of this rate (Mw₂/Mw₁) of increase in molecular weight. However, it is generally 10.00, preferably 5.00, more preferably 3.50.

According to the process of the present invention, a high-molecular weight aliphatic polyester having a molecular weight distribution relatively broad compared with the ring-opening (co)polymer before the chain lengthening can be obtained. The molecular weight distribution (Mw/Mn) represented by a ratio of a weight average molecular weight (Mw) of a ring-opening (co)polymer (i.e., high-molecular weight aliphatic polyester), whose molecular weight has been increased by the chain-lengthening reaction, to a number average molecular weight (Mn) thereof is preferably at least 1.90, more preferably at least 2.00, particularly preferably at least 2.10. No particular limitation is imposed on the upper limit of this molecular weight distribution (Mw/Mn). However, it is of the order of generally 5.50, often 4.50. If the molecular weight distribution becomes too broad, the properties of such a polymer as a whole may possibly be impaired.

The high-molecular weight aliphatic polyester obtained by the process according to the present invention is markedly improved in heat resistance compared with the ring-opening (co)polymer before the reaction with the oxazoline compound. A 1%-weight loss-starting temperature on heating of a polymer can be used as an index to the heat resistance. Assuming that a 1%-weight loss-starting temperature on heating of a ring-opening (co)polymer before chain lengthening is T₁, and a 1%-weight loss-starting temperature on heating of a high-molecular weight aliphatic polyester obtained by the chain-lengthening reaction of the ring-opening (co)polymer with an oxazoline compound is T₂, (T₂-T₁) can be controlled to preferably at least 3° C., more preferably at least 5° C. The resulting high-molecular weight aliphatic polyester shows a tendency to increase its heat resistance as the increase in the molecular weight is promoted by the reaction with the oxazoline compound. For example, (T₂-T₁) can be controlled to at least 15° C., further at least 20° C. However, the effect to improve the heat resistance shows a tendency to be somewhat saturated with the increase in the weight average molecular weight (Mw) by the chain-lengthening reaction, and the upper limit of (T₂-T₁) is of the order of generally 30° C., often 25° C.

The high-molecular weight aliphatic polyester according to the present invention may contain additives such as inorganic fillers, lubricants, plasticizers, colorants (dyes and pigments), heat stabilizers and conductive fillers; other thermoplastic resins; and/or the like if desired These additive components may be added before addition of the oxazoline compound, upon the addition or after the addition so far as they impair the chain-lengthening reaction of the ring-opening (co)polymer with the oxazoline compound. These additive components may also be added to the high-molecular weight aliphatic polyester formed after the chain-lengthening reaction of the ring-opening (co)polymer with the oxazoline compound.

### EXAMPLES

The present invention will hereinafter be described more specifically by the following Synthesis Examples, Examples and Comparative Examples. Measuring methods of physical properties are as follows:

(1) Weight Average Molecular Weight and Molecular Weight Distribution:

The weight average molecular weight (Mw) and molecular weight distribution (Mw/Mn) of each sample were measured under the following conditions making use of a gel permeation chromatography (GPC) analyzer. Sodium trifluoroacetate (product of Kanto Chemical Co., Inc.) is added and dissolved in hexafluoroisopropanol (a product of Central Glass Co., Ltd. was distilled for use) to prepare a 5 mM sodium trifluoroacetate solvent (A).

The solvent (A) is passed through a column (HFIP-LG+HFIP-806M×2; product of SHODEX) at 40° C. and a flow rate of 1 ml/min. Each 10 mg of 5 polymethyl methacrylate reagents (products of POLYMER LABORATORIES Ltd. respectively having already known molecular weights of 827,000, 101,000, 34,000, 10,000 and 2,000 and the solvent (A) are used to prepare 10 ml of a solution. A 100-μl portion of the solution is passed through the column to determine a detection peak time by detection of refractive index (RI). The detection peak time and molecular weight of each of the 5 standard samples are plotted, thereby preparing a calibration curve for molecular weight.

The solvent (A) is added to 10 mg of the sample to prepare 10 ml of a solution, and a 100-μl portion of this solution is passed through the column to determine a weight average molecular weight (Mw), a number average molecular weight (Mn) and a molecular weight distribution (Mw/Mn) from an elution curve thereof. C-R4AGPC Program Ver 1.2 manufactured by Shimadzu Corporation was used for calculation.

(2) 1%-Weight Loss-Starting Temperature on Heating:

A thermogravimetric analyzer TG50 manufactured by METTLER Co. was used, and nitrogen was caused to flow at a flow rate of 10 ml/min to heat an aliphatic polyester sample at a heating rate of 2° C./min from 50° C. under this nitrogen atmosphere, thereby determining a rate of weight loss. A temperature at which the weight of the aliphatic polyester has been reduced by 1% based on its weight (W₅₀) at 50° C. is precisely read out, and that temperature is regarded as a 1%-weight loss-starting temperature on heating.

(3) Torque Upon Melt Kneading:

A ring-opening (co)polymer and an oxazoline compound were melt-kneaded by means of a Labo Plastomill manufactured by Toyo Seiki Seisakusho, Ltd. to measure maximum torque at this time.

### Synthesis Example 1

A 10-liter autoclave was charged with 5 kg of glycolic acid (product of Wako Pure Chemical Industries, Ltd.), and the contents were heated to raise their temperature to from 170° C. to 200° C. over about 2 hours with stirring, whereby glycolic acid was condensed while distilling off water formed. The pressures of the system was then reduced to 20 kPa (200 mbar), and the reaction mixture was held for 2 hours to distill off low-boiling matter, thereby preparing a glycolic acid oligomer. The melting point Tm of the thus-obtained glycolic acid oligomer was 205° C.

A 10-liter flask was charged with 1.2 kg of the glycolic acid oligomer, and 5 kg of benzylbutyl phthalate (product of Junsei Chemical Co., Ltd.) as a solvent and 150 g of polypropylene glycol (#400, product of Junsei Chemical Co., Ltd.) as a solubilizing agent were added. The mixture was heated to about 270° C. under reduced pressure of 5 kPa (50 mbar) in a nitrogen gas atmosphere to conduct “solution-phase depolymerization” of the glycolic acid oligomer. Glycolide formed was azeotropically distilled out together with benzylbutyl phthalate. Cyclohexane in a volume about twice as much as the azeotropic mixture thus obtained was added to the mixture, whereby the glycolide was separated out of benzylbutyl phthalate and collected by filtration. This product was recrystallized with ethyl acetate and dried under reduced pressure to obtain purified glycolide.

### Synthesis Example 2

A glass-made test tube was charged with 100 g of the glycolide obtained in Synthesis Example 1 and 5 mg of tin tetrachloride to conduct polymerization at 200° C. for 3 hours. After the polymerization, protracted polymerization was conducted at 160° C. for 12 hours. After the polymerization, the reaction mixture was cooled, and a polymer formed was then taken out, ground and washed with acetone. Thereafter, the polymer was vacuum-dried at 30° C. to obtain the polymer. The above-described process was repeated to prepare a necessary amount of polyglycolic acid (polyglycolide).

### Example 1

Into a Labo Plastomill manufactured by Toyo Seiki Seisakusho, Ltd., were added 40 g of the polyglycolic acid obtained in Synthesis Example 2, and 0.28 g of 2,2′-m-phenylene-bis(2-oxazoline) (product of Kanto Chemical Co., Inc.) were then added to melt-knead the resultant mixture at 240° C. for 20 minutes. After completion of the kneading, a melt, which was a reaction product, was taken out to measure its physical properties. The results are shown in Table 1.

### Example 2

The process was conducted in the same manner as in Example 1 except that the amount of 2,2′-m-phenylene-bis(2-oxazoline) added was changed from 0.28 g to 0.40 g. The results are shown in Table 1.

### Example 3

The process was conducted in the same manner as in Example 1 except that the amount of 2,2′-m-phenylene-bis(2-oxazoline) added was changed from 0.28 g to 1.20 g. The results are shown in Table 1.

### Comparative Example 1

The process was conducted in the same manner as in Example 1 except that the polyglycolic acid obtained in Synthesis Example 2 was used by itself. The results are shown in Table 1.

TABLE 1

| | 2,2′-m-Phenylene-bis(2-oxazoline) | | | |
|---|---|---|---|---|
| | (parts by weight) | | | |
| | 0 | 0.7 | 1 | 3 |
| Torque upon melt kneading | 1.1 | 3.5 | 3.6 | 17 |
| (N · m) | | | | |
| Weight average molecular | 110,000 | 173,000 | 181,000 | 235,000 |
| weight (Mw) | | | | |
| Rate of increase in | 1.00 | 1.57 | 1.65 | 2.14 |
| molecular weight | | | | |
| Molecular weight | 1.75 | 2.20 | 2.30 | 3.47 |
| distribution (Mw/Mn) | | | | |
| 1%-Weight loss-starting | 230 | 237 | 252 | 252 |
| temperature on heating (° C.) | (0) | (+7) | (+22) | (+22) |
| (temperature increased) | | | | |
| | Comp. | Ex. 1 | Ex. 2 | Ex. 3 |
| | Ex. 1 | | | |

### INDUSTRIAL APPLICABILITY

According to the present invention, there can be provided high-molecular weight aliphatic polyesters that are ring-opening (co)polymers of cyclic esters such as glycolide and lactide, whose molecular weights have been highly increased, and whose heat resistance and forming or molding and processing ability have been improved. According to the present invention, there can also be provided a process for producing a high-molecular weight aliphatic polyester, by which the molecular weight of the resulting polymer can be easily increased to a desired molecular weight without need of always using high-purity glycolide or lactide as a starting material, and heat resistance and forming or molding and processing ability are also improved.

Since the high-molecular weight aliphatic polyesters according to the present invention are high in molecular weight and excellent in heat resistance and have a moderately broad molecular weight distribution, they can be used in a wide variety of fields as extruded products such as sheets, films and fibers, compression-molded products, injection-molded products, blow-molded products, composite materials (multi-layer films and multi-layer containers), and other formed or molded products.

1. A high-molecular weight aliphatic polyester, whose molecular weight has been highly increased by a chain-lengthening reaction of a ring-opening (co)polymer of at least one cyclic ester selected from the group consisting of glycolide and lactide with an oxazoline compound to the extent that a rate of increase in molecular weight represented by a ratio (Mw₂/Mw₁) of a weight average molecular weight (Mw₂) of a ring-opening (co)polymer after the chain lengthening to a weight average molecular weight (Mw₁) of the ring-opening (co)polymer before the chain lengthening amounts to at least 1.10.

2. The high-molecular weight aliphatic polyester according to claim 1, wherein the molecular weight is highly increased to the extent that the rate of increase in molecular weight amounts to at least 1.20.

3. The high-molecular weight aliphatic polyester according to claim 1, wherein the molecular weight is highly increased to the extent that the rate of increase in molecular weight amounts to at least 1.35.

4. The high-molecular weight aliphatic polyester according to claim 1, wherein the weight average molecular weight (Mw) of the ring-opening (copolymer, whose molecular weight has been increased by the chain-lengthening reaction, is at least 120,000.

5. The high-molecular weight aliphatic polyester according to claim 1, wherein the ring-opening (co)polymer having a weight average molecular weight of at most 110,000 before the chain lengthening is subjected to the chain-lengthening reaction into a high-molecular weight ring-opening (co)polymer having a weight average molecular weight of at least 150,000.

6. The high-molecular weight aliphatic polyester according to claim 1, wherein a difference (T₂-T₁) between a 1%-weight loss-starting temperature T₂ on heating of the ring-opening (co)polymer after the chain lengthening and a 1%-weight loss-starting temperature T₁ on heating of the ring-opening (co)polymer before the chain lengthening is at least 3° C.

7. The high-molecular weight aliphatic polyester according to claim 6, wherein the 1%-weight loss-starting temperature T₂ on heating of the ring-opening (co)polymer after the chain lengthening is at least 233° C.

8. The high-molecular weight aliphatic polyester according to claim 1, wherein a molecular weight distribution (Mw/Mn) represented by a ratio of a weight average molecular weight (Mw) of the ring-opening (co)polymer, whose molecular weight has been highly increased by the chain-lengthening reaction, to a number average molecular weight (Mn) thereof is at least 1.90.

9. The high-molecular weight aliphatic polyester according to claim 1, wherein the oxazoline compound is an oxazoline compound having at least two oxazoline ring structures in its molecule.

10. The high-molecular weight aliphatic polyester according to claim 9, wherein the oxazoline compound having at least two oxazoline ring structures in its molecule is 2,2′-m-phenylene-bis(2-oxazoline).

11. A process for producing a high-molecular weight aliphatic polyester, which comprises subjecting a ring-opening (co)polymer of at least one cyclic ester selected from the group consisting of glycolide and lactide to a chain-lengthening reaction with an oxazoline compound to highly increase the molecular weight thereof to the extent that a rate of increase in molecular weight represented by a ratio (Mw₂/Mw₁) of a weight average molecular weight (Mw₂) of a ring-opening (co)polymer after the chain lengthening to a weight average molecular weight (Mw₁) of the ring-opening (co)polymer before the chain lengthening amounts to at least 1.10.

12. The production process according to claim 11, wherein the molecular weight is highly increased to the extent that the rate of increase in molecular weight amounts to at least 1.20.

13. The production process according to claim 11, wherein the molecular weight is highly increased to the extent that the rate of increase in molecular weight amounts to at least 1.35.

14. The production process according to claim 11, wherein the ring-opening (co)polymer and the oxazoline compound are subjected to the chain-lengthening reaction at a temperature within a range of 100 to 300° C.

15. The production process according to claim 11, wherein the ring-opening (co)polymer and the oxazoline compound are subjected to the chain-lengthening reaction under conditions that the reaction temperature is not lower than the melting temperature of the ring-opening (co)polymer, but not higher than 300° C., and the reaction time is 5 to 40 minutes.

16. The production process according to claim 11, wherein the oxazoline compound is an oxazoline compound having at least two oxazoline ring structures in its molecule.

17. The production process according to claim 11, wherein the chain-lengthening reaction is conducted in the presence of the oxazoline compound in a proportion within a range of 0.005 to 10 parts by weight per 100 parts by weight of the ring-opening (co)polymer.

18. The production process according to claim 11, wherein the ring-opening (co)polymer having a weight average molecular weight of at most 110,000 before the chain lengthening is subjected to the chain-lengthening reaction into a high-molecular weight ring-opening (co)polymer having a weight average molecular weight of at least 150,000.

19. The production process according to claim 11, wherein a difference (T₂-T₁) between a 1%-weight loss-starting temperature T₂ on heating of the ring-opening (co)polymer after the chain lengthening and a 1%-weight loss-starting temperature T₁ on heating of the ring-opening (co)polymer before the chain lengthening is made at least 3° C. by the chain-lengthening reaction.

20. The production process according to claim 11, wherein a molecular weight distribution (Mw/Mn) represented by a ratio of a weight average molecular weight (Mw) of the ring-opening (co)polymer, whose molecular weight has been highly increased by the chain-lengthening reaction, to a number average molecular weight (Mn) thereof is at least 1.90.
